(19) United States
(12) Patent Application Publication
(10) Pub. No.: US 2014/0207905 A1
(43) Pub. Date: Jul. 24, 2014

(54) PLUG-IN DISTRIBUTION SYSTEM, IMAGE PROCESSING APPARATUS, PLUG-IN DISTRIBUTION CONTROL METHOD

(71) Applicant: FUJI XEROX CO., LTD., Tokyo (JP)

(72) Inventors: Takashi MURAKAMI, Kanagawa (JP); Haruhisa HOSHINO, Kanagawa (JP)

(73) Assignee: FUJI XEROX CO., LTD., Tokyo (JP)

(21) Appl. No.: 13/958,978

(22) Filed: Aug. 5, 2013

(30) Foreign Application Priority Data
Jan. 23, 2013 (JP) 2013-010065

(51) Int. Cl. H04L 29/08

(52) U.S. Cl. CPC H04L 67/10
USPC 709/217

(57) ABSTRACT

A plug-in distribution system includes a distribution server and an image processing apparatus. The distribution server distributes a plug-in. The image processing apparatus is connected to the distribution server via a network and receives a plug-in from the distribution server or another image processing apparatus and uses the received plug-in. The plug-in includes usage settings data that defines at least one of the number of usage times and transfer permissions concerning the plug-in, which are conditions to be imposed when the plug-in is used in the image processing apparatus. The image processing apparatus controls at least one of the usage and the transfer of the plug-in by using the usage settings data.

### CROSS-REFERENCE TO RELATED APPLICATIONS

This application is based on and claims priority under 35 USC 119 from Japanese Patent Application No. 2013-010065 filed Jan. 23, 2013.

### BACKGROUND

(i) Technical Field

The present invention relates to a plug-in distribution system, an image processing apparatus, and a plug-in distribution control method.

(ii) Related Art

In a system in which single or plural multifunction devices and a server are connected to a network, it may be possible to distribute plug-ins used for extending features of the multifunction devices from the server to the multifunction devices. In this case, it is desirable to manage redistribution of plug-ins and a degree of the usage of plug-ins in an appropriate manner.

### SUMMARY

According to an aspect of the invention, there is provided a plug-in distribution system including a distribution server and an image processing apparatus. The distribution server distributes a plug-in. The image processing apparatus is connected to the distribution server via a network and receives a plug-in from the distribution server or another image processing apparatus and uses the received plug-in. The plug-in includes usage settings data that defines at least one of the number of usage times and transfer permissions concerning the plug-in, which are conditions to be imposed when the plug-in is used in the image processing apparatus. The image processing apparatus controls at least one of the usage and the transfer of the plug-in by using the usage settings data.

### BRIEF DESCRIPTION OF THE DRAWINGS

An exemplary embodiment of the present invention will be described in detail based on the following figures, wherein:

FIG. 1 is a block diagram of a system of an exemplary embodiment;

FIG. 2 is a block diagram of the configuration of a multifunction device of an exemplary embodiment;

FIG. 3 illustrates an operation for distributing a plug-in from a distribution server to a multifunction device;

FIG. 4 illustrates distribution settings and usage settings which are set in a plug-in;

FIG. 5 illustrates a MOVE/COPY operation performed between multifunction devices;

FIG. 6 is a flowchart of processing executed in an exemplary embodiment; and

FIG. 7 is a flowchart of processing executed in an exemplary embodiment.

### DETAILED DESCRIPTION

An exemplary embodiment of the present invention will be described below with reference to the drawings. The term “plug-in” discussed in this exemplary embodiment refers to a program which is executed in cooperation with a certain program in order to extend features of this certain program.

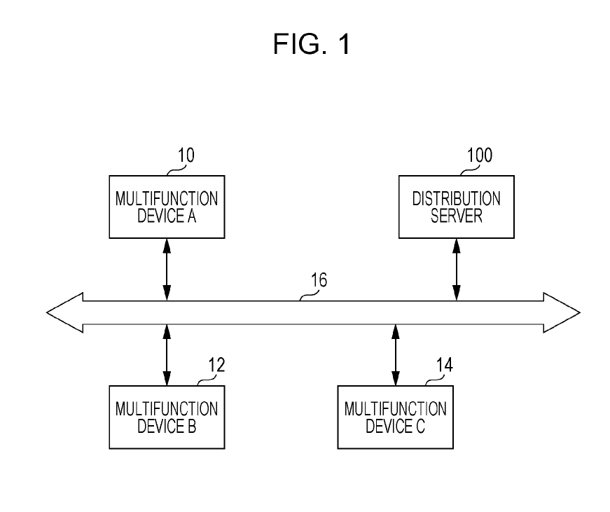

FIG. 1 is a block diagram of a system of this exemplary embodiment. A multifunction device 10, which serves as an image processing apparatus, is connected to a distribution server 100 via a network 16, such as the Internet. The distribution server 100 may be a server which provides so-called cloud services. The term “cloud” in this exemplary embodiment refers to a computer group which exists on the Internet, in particular, a server computer on the Internet. In addition to the multifunction device 10, there are other multifunction devices 12 and 14, which are also connected to the distribution server 100 via the network 16. For the sake of distinguishing the multifunction devices 10, 12, and 14 from each other, the multifunction devices 10, 12, and 14 are shown as a multifunction device A, a multifunction device B, and a multifunction device C, respectively, in FIG. 1.

In FIG. 1, all of the multifunction devices 10, 12, and 14 are connected to the distribution server 100 via the network 16. However, only the multifunction device 10 may be connected to the distribution server 100, and the multifunction devices 12 and 14 may be connected to the multifunction device 10 via a network different from the network 16, for example, a local area network (LAN).

The multifunction device 10 has various basic functions (features), such as a function of scanning documents, a function of transferring image data obtained by scanning documents to the distribution server 100 via the network 16, a function of downloading image data from the distribution server 100, and a function of viewing/printing image data. The multifunction device 10 also has a function of requesting the distribution server 100 to distribute a plug-in for extending the functions (features) of the multifunction device 10, a function of downloading a plug-in returned from the distribution server 100 in response to a request made by the multifunction device 10, a function of installing and using a downloaded plug-in, and a function of transferring a downloaded plug-in to the multifunction device 12 or 14 if necessary. The other multifunction devices 12 and 14 have functions similar to those of the multifunction device 10.

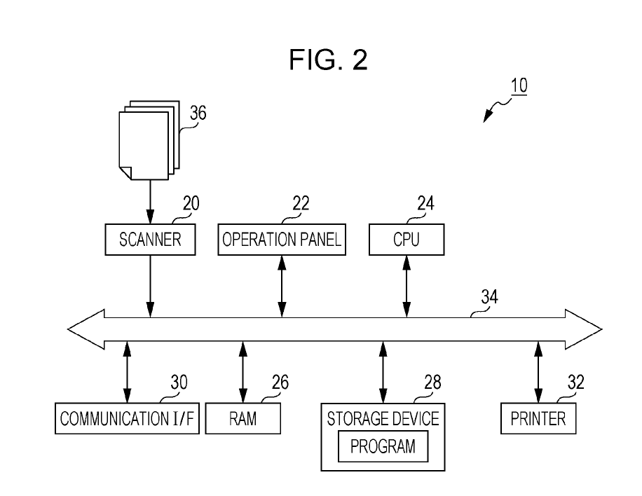

FIG. 2 is a block diagram of the configuration of the multifunction device 10. The multifunction device 10 includes a scanner 20, an operation panel 22, a central processing unit (CPU) 24, a random access memory (RAM) 26, a storage device 28, a communication interface (I/F) 30, a printer 32, and a bus 34. The multifunction device 10, which includes the CPU 24, the RAM 26, and the storage device 28, implements the above-described various basic functions by reading and executing a program and necessary plug-ins stored in the storage device 28. Accordingly, the multifunction device 10 may be considered as a computer, in particular, a client computer.

The scanner 20 scans a document 36 and forms an image of the document 36 into image data, and stores the image data in the RAM 26. The format of the image data is not particularly restricted, and may be, for example, Portable Document Format (PDF).

The operation panel 22 sets various parameters used when a user scans the document 36 by using the scanner 20. The operation panel 22 also sets various settings used when a user transfers (uploads) image data obtained by scanning the document 36 to the distribution server 100 and sets various settings used when a user views/prints a document stored in the distribution server 100. The operation panel 22 also sets various settings used when a user requests the distribution server 100 to distribute a required plug-in or when a user transfers a plug-in to the multifunction device 12 or 14.

The storage device 28 stores a processing program and plug-ins downloaded from the distribution server 100, and also stores various items of image data downloaded from the distribution server 100.

The CPU 24 reads and executes the processing program and plug-ins stored in the storage device 28 so as to control operations of the elements of the multifunction device 10 in accordance with the processing program and the plug-ins. More specifically, the CPU 24 transfers image data to the distribution server 100 via the communication I/F 30 in accordance with a request set by the operation panel 22. The CPU 24 also downloads image data stored in the distribution server 100 in response to a request set by the operation panel 22, and displays the downloaded image data on the operation panel 22 so as to allow a user to view the image data. At the same time, the CPU 24 outputs the downloaded image data to the printer 32 and causes the printer 32 to print the image data. Additionally, the CPU 24 controls the usage of a plug-in in accordance with usage settings appended to the plug-in. The usage settings will be discussed later.

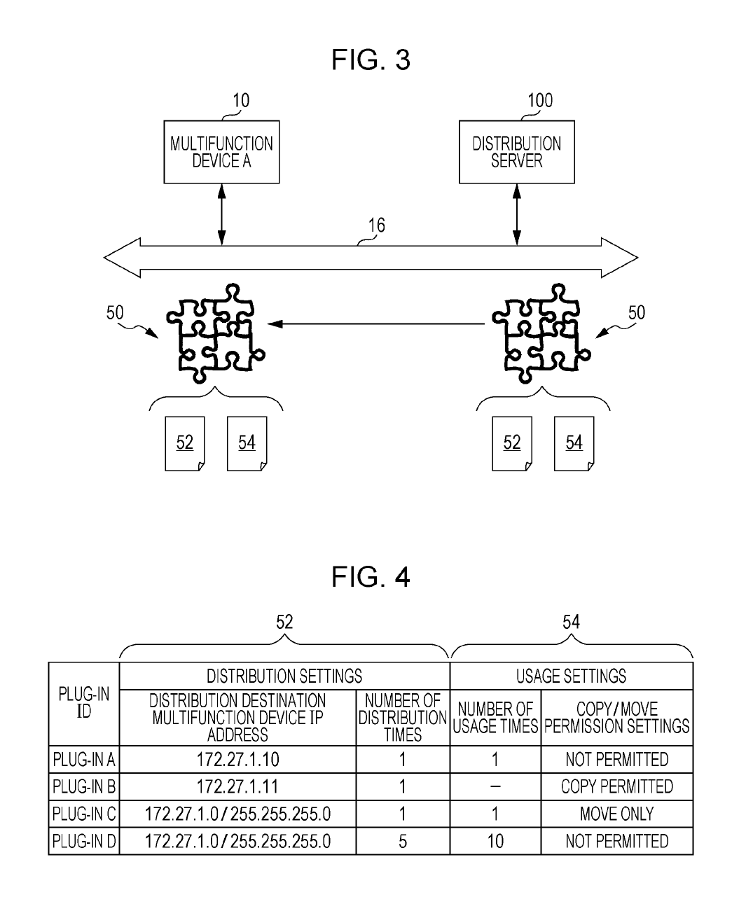

FIG. 3 schematically illustrates an operation for distributing a plug-in from the distribution server 100 to the multifunction device 10 in response to a request from the multifunction device 10.

Plug-ins 50 are stored in a memory of the distribution server 100, and upon receiving a plug-in request command from the CPU 24 of the multifunction device 10, a CPU of the distribution server 100 reads a requested plug-in 50 from the memory in response to the plug-in request command, and distributes the plug-in 50 to the multifunction device 10 via the network 16.

Distribution settings data (or a distribution settings file) 52 and usage settings data (or a usage settings file) 54 are appended to a plug-in 50 in advance. The distribution settings data 52 indicates conditions to be imposed when the distribution server 100 distributes the plug-in 50 to the multifunction device 10 or another multifunction device. The usage settings data 54 indicates conditions to be imposed when the plug-in 50 is used in the multifunction device 10 or another multifunction device. The distribution settings data 52 and the usage settings data 54 are appended to each plug-in 50. The content of the distribution settings data 52 and that of the usage settings data 54 are different according to the type of plug-in 50. Accordingly, the distribution settings data 52 and the usage settings data 54 may be considered as metadata of the plug-in 50.

Upon receiving a request command for a plug-in 50 from the multifunction device 10, the distribution server 100 accesses the distribution settings data 52 of the plug-in 50, analyzes the content of the distribution settings data 52, and then determines whether or not it is possible to distribute the plug-in 50 to the multifunction device 10. If the distribution server 100 determines that it is possible to distribute the plug-in 50, it distributes the plug-in 50 to the multifunction device 10.

Meanwhile, the CPU 24 of the multifunction device 10 analyzes the usage settings data 54 appended to the plug-in 50 distributed from the distribution server 100 and controls the usage of the plug-in 50. For example, if the usage settings data 54 contains data concerning a restriction on the number of usage times of the plug-in 50, the multifunction device 10 uses the plug-in 50 in accordance with the restricted number of uses indicated in the data. If the usage settings data 54 contains data concerning a restriction on the transfer of the plug-in 50 to the other multifunction devices 12 and 14, the multifunction device 10 transfers the plug-in 50 in accordance with transfer conditions indicated in the data.

The distribution of a plug-in 50 is controlled in the distribution server 100 in accordance with the distribution settings data 52, and the usage of a plug-in 50 is controlled in the multifunction device 10 in accordance with the usage settings data 54. In other words, the distribution of the plug-in 50 is controlled by using the distribution settings data 52 appended to the plug-in 50, and the usage of the distributed plug-in 50 is controlled by using the usage settings data 54 appended to the plug-in 50.

FIG. 4 illustrates an example of the distribution settings data 52 and an example of the usage settings data 54, which are set for each plug-in. In FIG. 4, there are four plug-ins, i.e., a plug-in A, a plug-in B, a plug-in C, and a plug-in D, and the distribution settings data 52 and the usage settings data 54 are appended to each of the plug-ins.

The distribution settings data 52 defines an IP address, which serves as an ID for specifying a distribution destination multifunction device, and the number of distribution times. The usage settings data 54 defines the number of usage times and transfer permissions, and more specifically, COPY/MOVE permission settings, concerning a certain plug-in. In this case, the number of usage times refers to the total number of usage times, COPY means that a copy of a certain plug-in is transferred to another multifunction device while keeping an original plug-in, and MOVE means that an original plug-in is transferred to another multifunction device. That is, COPY and MOVE are distinguished from each other, depending on whether or not an original plug-in is kept.

In FIG. 4, as the distribution settings data 52 of the plug-in A, the IP address of a destination multifunction device is set to be “172.27.1.10” and the number of distribution times is set to be “one”. Accordingly, the plug-in A is distributed only to a multifunction device having the above-described IP address, and the number of distribution times is restricted to one. Even if the distribution server 100 receives a request command for the plug-in A from a multifunction device having an IP address other than the above-described IP address, it rejects the request command and does not distribute the plug-in A since the IP address of the multifunction device is different from the IP address of the distribution destination. If the distribution server 100 has received a request command for the plug-in A from a multifunction device having the above-described IP address and has distributed the plug-in A, it updates the number of distribution times of the plug-in A by decrementing it. Accordingly, after distributing the plug-in A, the number of distribution times indicated in the distribution settings data 52 of the plug-in A stored in the memory of the distribution server 100 is set to be 0 (1−1=0). Thus, even if the distribution server 100 receives a request command for the plug-in A from the multifunction device again, it rejects this request command.

In FIG. 4, in the usage settings data 54 of the plug-in A, the number of usage times is set to be “one”, and the COPY/MOVE permission settings are set to be “not permitted”. Accordingly, the use of the plug-in A is restricted to only once, and neither COPY nor MOVE is permitted. If the plug-in A is distributed to a multifunction device having an IP address “172.27.1.10”, it may be used in this multifunction device only once. That is, the CPU 24 of this multifunction device analyzes the usage settings data 54 of the plug-in A and identifies that the number of usage times is “one”, and thus uses the plug-in A only once. After using the plug-in A, the CPU 24 updates the number of usage times by decrementing it. Even if the multifunction device accesses the plug-in A again, the CPU 24 does not execute the plug-in A since the number of usage times is set to be 0 (1−1=0). Moreover, even if a request command for the plug-in A is received from another multifunction device, the CPU 24 rejects this request command since COPY/MOVE is set to be “not permitted”.

In FIG. 4, in the distribution settings data 52 of the plug-in B, the IP address of a destination multifunction device is set to be “172.27.1.11” and the number of distribution times is set to be “one”. Accordingly, the plug-in B is distributed only to a multifunction device having the above-described IP address, and the number of distribution times is restricted to one. Even if the distribution server 100 receives a request command for the plug-in B from a multifunction device having an IP address other than the above-described IP address, it rejects the request command and does not distribute the plug-in B since the IP address of the multifunction device is different from the IP address of the distribution destination. If the distribution server 100 has received a request command for the plug-in B from a multifunction device having the above-described IP address and has distributed the plug-in B, it updates the number of distribution times of the plug-in B by decrementing it. Accordingly, after distributing the plug-in B, the number of distribution times indicated in the distribution settings data 52 of the plug-in B stored in the memory of the distribution server 100 is set to be 0 (1−1=0). Thus, even if the distribution server 100 receives a request command for the plug-in B from the multifunction device again, it rejects this request command.

In FIG. 4, in the usage settings data 54 of the plug-in B, the number of usage times is set to be “unlimited”, and the COPY/MOVE permission settings are set to be “COPY permitted”. Accordingly, the usage times of the plug-in B is unlimited, and COPY is permitted, and MOVE is not permitted. If the plug-in B is distributed to a multifunction device having an IP address “172.27.1.11”, it may be used in this multifunction device unlimitedly. Moreover, if the plug-in B is copied and transferred to another multifunction device, it may be used unlimitedly in this multifunction device. That is, the CPU 24 of the multifunction device having the above-described IP address analyzes the usage settings data 54 of the plug-in B and identifies that the number of usage times is “unlimited”, and thus uses the plug-in B as many times as needed. Since the usage times are unlimited, the CPU 24 does not decrement the number of usage times even after it uses the plug-in B. Alternatively, as the number of usage times, a sufficiently large value (a value which can be substantially considered as an unlimited value) may be set, and the number of usage times may be decremented every time the plug-in B is used. Even if the CPU 24 receives a MOVE request command for the plug-in B from another multifunction device, it rejects this request command. On the other hand, if the CPU 24 receives a COPY request command for the plug-in B from another multifunction device, it creates a copy of the plug-in B and transfers the copied plug-in B to the multifunction device. When copying the plug-in B, the CPU 24 also copies the distribution settings data 52 and the usage settings data 54 appended to the plug-in B and appends the copied distribution settings data 52 and usage settings data 54 to the copied plug-in B. Accordingly, when transferring a copied plug-in B to a multifunction device which has sent a COPY request command, the CPU 24 also transfers the distribution settings data 52 and the usage settings data 54 together with the copied plug-in B. If the number of usage times is decremented, the usage settings data 54 indicating the updated number of usage times is copied.

In FIG. 4, in the distribution settings data 52 of the plug-in C, the IP address of a destination multifunction device is set to be “172.27.1.0”, the subnet mask is set to be “255.255.255.0”, and the number of distribution times is set to be “one”. Accordingly, the plug-in C is distributed only to a multifunction device having the above-described IP address contained in the above-described subnet mask, and the number of distribution times is restricted to one.

In FIG. 4, in the usage settings data 54 of the plug-in C, the number of usage times is set to be “one”, and the COPY/MOVE permission settings are set to be “MOVE only”. Accordingly, the use of the plug-in C is restricted to only once, and MOVE is permitted and COPY is not permitted. When the plug-in C is distributed to a multifunction device having the above-described IP address, the plug-in C may be used only once either in the multifunction device which has received the plug-in C or in another multifunction device. For example, if the plug-in C is distributed to a multifunction device having the IP address “172.27.1.20” contained in the above-described subnet mask, and if the plug-in C is used in this source multifunction device, the CPU 24 of this multifunction device updates the number of usage times to be 0 (1−1=0) by decrementing it. Accordingly, even if the plug-in C is transferred to a destination multifunction device that may access the source multifunction device, the destination multifunction device is unable to use the plug-in C. In contrast, if the plug-in C is distributed to a multifunction device having the IP address “172.27.1.20” contained in the above-described subnet mask, and if the plug-in C is not used in this source multifunction device, the CPU 24 of this multifunction device maintains the number of usage times to be “one” without updating it. Accordingly, if the plug-in C is transferred to another multifunction device which may access the source multifunction device, it may be used only once in the destination multifunction device. If the CPU 24 receives a MOVE request command for the plug-in C from another multifunction device, it creates a copy of the plug-in C and deletes the original plug-in C from the storage device 28, and then transfers the copied plug-in C to the multifunction device which has sent the MOVE request command. When copying the plug-in C, the distribution settings data 52 and the usage settings data 54 appended to the plug-in C are also copied and transferred, in a manner similar to a case in which a plug-in is transferred in response to a COPY request command.

In FIG. 4, in the distribution settings data 52 of the plug-in D, the IP address of a destination multifunction device is set to be “172.27.1.0”, the subnet mask is set to be “255.255.255.0”, and the number of distribution times is set to be “five”. Accordingly, the plug-in D is distributed only to a multifunction device having the above-described IP address contained in the above-described subnet mask, and the number of distribution times is restricted to five.

In FIG. 4, in the usage settings data 54 of the plug-in D, the number of usage times is set to be “ten”, and the COPY/MOVE permission settings are set to be “not permitted”. Accordingly, the total number of usage times of the plug-in D in each destination multifunction device is restricted to ten, and neither MOVE nor COPY is permitted. For example, if the plug-in D is distributed to five multifunction devices contained in the above-described subnet mask, it may be used up to ten times in each multifunction device. Every time the plug-in D is used, the CPU 24 of each multifunction device updates the number of usage times by decrementing it, and when the number of usage times reaches 0, the CPU 24 disables the plug-in D.

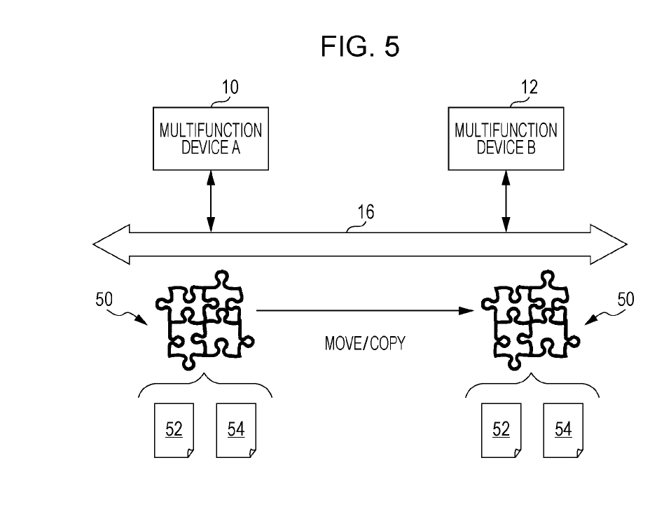

FIG. 5 schematically illustrates processing between multifunction devices when a MOVE or COPY request is sent and received. This processing is executed when the multifunction device 10 downloads a plug-in 50 from the distribution server 100 and transfers the plug-in 50 to another multifunction device 12.

The CPU 24 of the multifunction device 10 stores the plug-in 50 downloaded from the distribution server 100 in the storage device 28. Upon receiving a COPY request command from the multifunction device 12, the CPU 24 accesses the usage settings data 54 appended to the plug-in 50 stored in the storage device 28, analyzes the content of the usage settings data 54, and then determines whether or not COPY is permitted. If it is found that COPY is permitted, the CPU 24 copies the plug-in 50, the distribution settings data 52, and the usage settings data 54, and transfers the copied plug-in 50 together with the copied distribution settings data 52 and usage settings data 54 to the multifunction device 12. If COPY is not permitted, the CPU 24 transfers a message indicating the rejection of the request to the multifunction device 12.

Upon receiving a MOVE request command from the multifunction device 12, the CPU 24 accesses the usage settings data 54 appended to the plug-in 50 stored in the storage device 28, analyzes the content of the usage settings data 54, and then determines whether or not MOVE is permitted. If it is found that MOVE is permitted, the CPU 24 copies the plug-in 50, the distribution settings data 52, and the usage settings data 54, and transfers the copied plug-in 50 together with the copied distribution settings data 52 and usage settings data 54 to the multifunction device 12. The CPU 24 also deletes the original plug-in 50 stored in the storage device 28 and the distribution settings data 52 and the usage settings data 54 appended to the plug-in 50. If MOVE is not permitted, the CPU 24 transfers a message indicating the rejection of the request to the multifunction device 12.

The above-described processing will be described by referring to FIG. 4. If the above-described plug-in 50 is the plug-in A or the plug-in D, the usage settings data 54 indicates that neither COPY nor MOVE is permitted, and thus, the CPU 24 of the multifunction device 10 transfers a message indicating that the request has been rejected to the multifunction device 12. If the plug-in 50 is the plug-in B, the usage settings data 54 indicates that COPY is permitted. Accordingly, if the CPU 24 of the multifunction device 10 receives a COPY request command from the multifunction device 12, it transfers a copy of the plug-in B in response to the COPY request command. If the plug-in 50 is the plug-in C, the usage settings data 54 indicates that MOVE only is permitted. Accordingly, if the CPU 24 of the multifunction device 10 receives a MOVE request command from the multifunction device 12, it transfers the plug-in C in response to the MOVE request command.

In this manner, the distribution settings data 52 and the usage settings data 54 are appended to each plug-in, and a distribution destination and the number of distribution times are controlled by using the distribution settings data 52, while the number of usage times and transfer permissions (COPY/MOVE) are controlled by using the usage settings data 54. Accordingly, even if there are plural multifunction devices, the load on the distribution server 100 is not increased. Additionally, since the total number of usage times is controlled by using the usage settings data 54, even if a certain user uses a plug-in by using plural multifunction devices, it is possible to easily control the number of times the user uses the plug-in. The function of transferring a plug-in may also be controlled by using the usage settings data 54, and thus, it is possible to perform control such that the usage of a plug-in is permitted only in a specific multifunction device.

In this exemplary embodiment, by a combination of the number of usage times and transfer permissions, i.e., COPY/MOVE permission settings, indicated in the usage settings data 54, a variety of control types concerning the usage of a plug-in 50 may be implemented without increasing the load on the distribution server 100. Specific examples of the control types concerning the usage of the plug-in 50 are as follows.

(1) If it is desired that the plug-in 50 be used only in a specific multifunction device, COPY/MOVE is set to be “not permitted”.
(2) If it is desired that the plug-in 50 be used only once though it is usable in any multifunction device, the number of usage times is set to be “one”, and COPY/MOVE is set to be “MOVE only”.
(3) If it is desired that the plug-in 50 be used as many times as needed in any multifunction device without any restriction, the number of usage times is set to be “unlimited”, and COPY/MOVE is set to be “COPY permitted”.

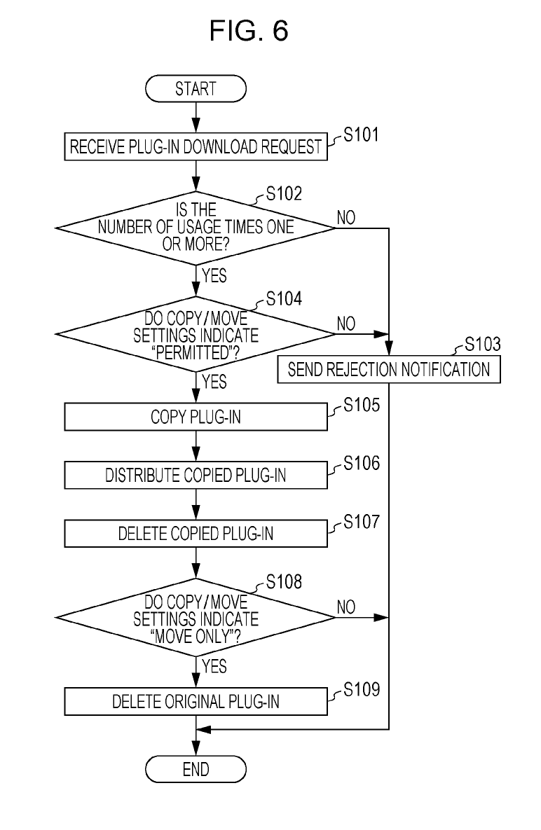

FIG. 6 is a flowchart of processing executed in this exemplary embodiment, and more specifically, processing executed by the multifunction device 10 shown in FIG. 5 when receiving a download request from another multifunction device.

In step S101, the CPU 24 of the multifunction device 10 receives a plug-in download request from another multifunction device, for example, the multifunction device 12.

Then, in step S102, the CPU 24 accesses the usage settings data 54 of the plug-in 50 stored in the storage device 28 and determines whether or not the number of usage times is one or more. If it is determined in step S102 that the number of usage times is not one or more, that is, it is already 0, it is no longer possible to use the plug-in 50 and there is no point in transferring the plug-in 50 to the multifunction device 12. Accordingly, the CPU 24 proceeds to step S103 to transfer a rejection notification to the multifunction device 12. In this case, the CPU 24 may transfer a message indicating that it is not possible to transfer the plug-in 50 since the number of usage times has already reached 0.

If it is found in step S102 that the number of usage times is one or more, the CPU 24 proceeds to step S104 to determine whether or not COPY/MOVE settings of the usage settings data 54 of the plug-in 50 indicate “permitted”. If COPY/MOVE settings indicate “not permitted”, the CPU 24 proceeds to step S103 to transfer a rejection notification to the multifunction device 12 in a manner similar to a case in which the result of step S102 is NO. If COPY/MOVE settings indicate that either COPY or MOVE is permitted, the CPU 24 proceeds to step S105 to create a copy of the plug-in 50 and temporarily stores it in the RAM 26. Then, in step S106, the CPU 24 transfers and distributes the copied plug-in 50 to the multifunction device 12. As stated above, when copying the plug-in 50, the CPU 24 also copies the distribution settings data 52 and the usage settings data 54 and distributes them to the multifunction device 12. Then, in step S107, the CPU 24 deletes the copied plug-in 50 stored in the RAM 26. At this point, the original plug-in 50 stored in the storage device 28 is still kept therein.

The CPU 24 then determines in step S108 whether or not COPY/MOVE settings indicate MOVE only. If the result of step S108 is YES, the CPU 24 proceeds to step S109 to delete the original plug-in 50 stored in the storage device 28.

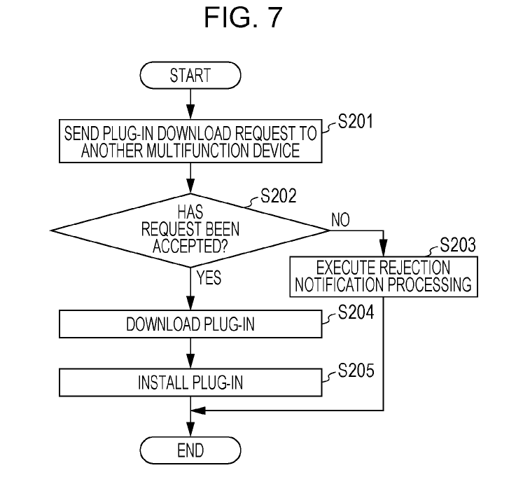

FIG. 7 is a flowchart of processing executed in this exemplary embodiment, and more specifically, processing executed by the multifunction device 12 shown in FIG. 5 when sending a download request to another multifunction device.

In step S201, the CPU 24 of the multifunction device 12 sends a request command to download the plug-in 50 to another multifunction device, for example, the multifunction device 10.

Then, in step S202, the CPU 24 of the multifunction device 12 determines whether or not the download request has been accepted. As stated above, if the number of usage times has already reached 0, or if COPY/MOVE settings indicate “not permitted”, the multifunction device 10, which has received the download request, transfers a rejection notification to the multifunction device 12. Accordingly, the CPU 24 of the multifunction device 12, which has received this rejection notification, determines in step S202 that the download request has not been accepted, and proceeds to step S203 to execute predetermined rejection notification processing. More specifically, the CPU 24 queries the multifunction device 10 about a reason why the download request has been rejected, and displays a rejection reason on the operation panel 22 of the multifunction device 12, or stores information that the download request has been rejected in the storage device 28 as a log.

If it is found in step S202 that the download request has been accepted, the CPU 24 proceeds to step S204 to download the plug-in 50 transferred from the multifunction device 10. Then, in step S205, the CPU 24 stores and installs the downloaded plug-in 50 in the storage device 28. The distribution settings data 52 and the usage settings data 54 are appended to the downloaded plug-in 50, and when the plug-in 50 is used in the multifunction device 12, the CPU 24 updates the number of usage times indicated in the usage settings data 54 by decrementing it.

The present invention has been discussed through the above-described exemplary embodiment. However, the present invention is not restricted to this exemplary embodiment, and various modifications may be made.

For example, in the above-described exemplary embodiment, the distribution server 100 and the multifunction devices 10, 12, and 14 are connected to one another via the network 16, as shown in FIG. 1. In this system, there may be plural distribution servers 100, and the number of multifunction devices is not particularly restricted. In this system, the most basic configuration is a combination of the distribution server 100 and the multifunction device 10. In this case, the destination to which a plug-in 50 is distributed is restricted to the multifunction device 10, and the distributed plug-in 50 is used only in the multifunction device 10 and is not transferred. Accordingly, the practical sense of the provision of the distribution settings data 52 and the usage settings data 54 is relatively small. Even in this case, however, if the number of usage times of the plug-in 50 in the multifunction device 10 is restricted, it is possible to effectively utilize information concerning the number of usage times indicated in the usage settings data 54. Additionally, there may be a specific plug-in which may not be desirable to be distributed to the multifunction device 10 depending on the type of device, in which case, it is possible to effectively utilize the destination IP address indicated in distribution settings data 52. A typical example of the system configuration of this exemplary embodiment is a configuration in which the multifunction devices 10 and 12 are connected to a network, and the multifunction device 10 is connected via the Internet to the distribution server 100 which provides cloud services. If a plug-in 50 is used, not in the multifunction device 10, but in the multifunction device 12, the multifunction device 10 first receives the plug-in 50 from the distribution server 100 and stores it in the storage device 28. Then, the multifunction device 12 sends a MOVE request command for the plug-in 50 to the multifunction device 10, and the multifunction device 10 transfers (MOVE) the plug-in 50 to the multifunction device 12 in response to this MOVE request command. Since this request is a MOVE request, the plug-in 50 is deleted from the multifunction device 10 and is not kept therein.

In this exemplary embodiment, when distributing a plug-in 50 from the distribution server 100 to the multifunction device 10, the distribution settings data 52 and the usage settings data 54 are also distributed together with the plug-in 50. Additionally, when transferring (COPY/MOVE) a plug-in 50 from the multifunction device 10 to the multifunction device 12, the distribution settings data 52 and the usage settings data 54 are also distributed together with the plug-in 50. In this exemplary embodiment, however, after distributing a plug-in 50 from the distribution server 100, the distribution server 100 is basically no longer concerned with the management of the distributed plug-in 50. Thus, when distributing the plug-in 50 from the distribution server 100 to the multifunction device 10, the distribution settings data 52 may be deleted from the plug-in 50. In this case, only the usage settings data 54 is appended to the plug-in 50, and the multifunction device 10 or 12 may perform control of the usage or the transfer of the plug-in 50 by utilizing the usage settings data 54.

In this exemplary embodiment, as shown in FIG. 4, the distribution settings data 52 includes a distribution destination multifunction device IP address and the number of distribution times, and the usage settings data 54 includes the number of usage times and COPY/MOVE permission settings. More simply, however, the distribution settings data 52 may include only a distribution destination or only the number of distribution times, and the usage settings data 54 may include only the number of usage times or only COPY/MOVE permission settings. In short, as the distribution settings data 52, at least one of a distribution destination and the number of distribution times may be used, and as the usage settings data 54, at least one of the number of usage times and transfer permission settings may be used. Specific examples of combinations of the distribution settings data 52 and the usage settings data 54 are as follows:

(a) as the distribution settings data 52, the distribution destination only, and as the usage settings data 54, the number of usage times only;
(b) as the distribution settings data 52, the number of distribution times only, and as the usage settings data 54, the number of usage times only;
(c) as the distribution settings data 52, the distribution destination only, and as the usage settings data 54, the transfer permission settings only;
(d) as the distribution settings data 52, the number of distribution times only, and as the usage settings data 54, the transfer permission settings only;
(e) as the distribution settings data 52, the distribution destination and the number of distribution times, and as the usage settings data 54, the number of usage times only;
(f) as the distribution settings data 52, the distribution destination and the number of distribution times, and as the usage settings data 54, the transfer permission settings only;
(g) as the distribution settings data 52, the distribution destination only, and as the usage settings data 54, the number of usage times and the transfer permission settings;
(h) as the distribution settings data 52, the number of distribution times only, and as the usage settings data 54, the number of usage times and the transfer permission settings; and
(i) as the distribution settings data 52, the distribution destination and the number of distribution times, and as the usage settings data 54, the number of usage times and the transfer permission settings.

In this exemplary embodiment, when a plug-in 50 is distributed from the distribution server 100, the number of distribution times is decremented, and when a plug-in 50 is used in a multifunction device, such as the multifunction device 10, the number of usage times is decremented. Alternatively, the number of distribution times or the number of usage times may be managed by using another variable, and the variable may be verified against a preset number of distribution times in the distribution settings data 52 or a preset number of usage times in the usage settings data 54. For example, the usage settings data 54 may include a variable C indicating the number of actual usage times, as well as the preset number of usage times, and every time the plug-in 50 is used, the variable C is incremented by one. When the value of the variable C reaches the preset number of usage times, it is assumed that the number of actual usage times has reached the maximum number of usage times, and the usage of the plug-in 50 is no longer permitted.

In this exemplary embodiment, the distribution settings data 52 may include the user ID of a distribution destination, in addition to a distribution destination and the number of distribution times. Normally, before utilizing the multifunction device 10, a user conducts user authentication by inputting a user ID and a password. Accordingly, when a request to download a plug-in 50 is sent from the multifunction device 10 to the distribution server 100, the user ID may also be sent together with the request, and the distribution server 100 may verify the received user ID against the user ID of a distribution destination contained in the distribution settings data 52, and may then determine whether or not the plug-in 50 will be distributed. The user ID included in the distribution settings data 52 is also set for each plug-in 50.

In this exemplary embodiment, the distribution settings data 52 and the usage settings data 54 are appended to a plug-in 50. In this case, the distribution settings data 52 and the usage settings data 54 may be embedded in program data of a plug-in 50, or may be related to a plug-in 50 as a different file.

In this exemplary embodiment, a case in which a plug-in 50 is distributed from the distribution server 100 has been discussed. However, a plug-in 50 may be replaced by another data or program. For example, instead of the plug-in 50, image data may be distributed and used, in which case, a distribution destination and the number of usage times for this image data may be controlled. This exemplary embodiment is also applicable to such a case.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A plug-in distribution system comprising:
a distribution server that distributes a plug-in; and
an image processing apparatus that is connected to the distribution server via a network and that receives a plug-in from the distribution server or another image processing apparatus and uses the received plug-in, wherein
the plug-in includes usage settings data that defines at least one of the number of usage times and transfer permissions concerning the plug-in, which are conditions to be imposed when the plug-in is used in the image processing apparatus, and
the image processing apparatus controls at least one of the usage and the transfer of the plug-in by using the usage settings data.

2. The plug-in distribution system according to claim 1, wherein:
the plug-in further includes distribution settings data that defines at least one of a distribution destination and the number of distribution times concerning the plug-in, which are conditions to be imposed when the plug-in is distributed from the distribution server; and
the distribution server controls at least one of a distribution destination and the number of distribution times concerning the plug-in by using the distribution settings data.

3. An image processing apparatus comprising:
a receiver that receives a plug-in distributed from a distribution server;
a memory that stores therein the plug-in received by the receiver; and
a controller that controls at least one of the usage and the transfer of the plug-in on the basis of usage settings data which is included in the plug-in and which defines at least one of the number of usage times and transfer permissions concerning the plug-in.

4. The image processing apparatus according to claim 3, wherein, when the plug-in has been used, the controller updates the number of usage times by decrementing the number of usage times.

5. The image processing apparatus according to claim 3, wherein, when transferring the plug-in, the controller also transfers the usage settings data together with the plug-in.

6. A plug-in distribution control method comprising:
controlling, when distributing, from a distribution server to an image processing apparatus via a network, a plug-in to which distribution settings data defining a distribution destination and the number of distribution times concerning the plug-in and usage settings data defining the number of usage times and transfer permissions concerning the plug-in are appended, a distribution destination and the number of distribution times concerning the plug-in by using the distribution settings data; and
controlling the usage of the plug-in by using the usage settings data if the plug-in is used in the image processing apparatus which has received the plug-in from the distribution server, and controlling the transfer of the plug-in by using the usage settings data if the plug-in is transferred to another image processing apparatus.
